(19) United States
(12) Patent Application Publication
(10) Pub. No.: US 2026/0128337 A1
(43) Pub. Date: May 7, 2026

(54) FUEL CELL SYSTEM

(71) Applicant: AISAN KOGYO KABUSHIKI KAISHA, Obu-shi (JP)

(72) Inventor: Daisaku ASANUMA, Gamagori-shi (JP)

(73) Assignee: AISAN KOGYO KABUSHIKI KAISHA, Obu-shi (JP)

(21) Appl. No.: 19/352,996

(22) Filed: Oct. 8, 2025

(30) Foreign Application Priority Data
Nov. 7, 2024 (JP) 2024-194995

(51) Int. Cl. H01M 8/04858; H01M 8/04537

(52) U.S. Cl. CPC H01M 8/0494; H01M 8/04589; H01M 2250/20

(57) ABSTRACT

A fuel cell system includes three FC stacks connected in parallel, a single battery to which all the FC stacks, and a controller, but no DC-DC converter. The controller is configured to simultaneously measure the FC currents of the three FC stacks. The controller controls power generation of the three FC stacks based on differences between the simultaneously measured FC currents.

### CROSS-REFERENCE TO RELATED APPLICATIONS

This application is based upon and claims the benefit of priority to Japanese Patent Application No. 2024-194995 filed on Nov. 7, 2024, the entire contents of which are incorporated herein by reference.

### BACKGROUND

### Technical Field

The disclosure relates to a fuel cell system including a fuel cell and a battery charged with electric power generated by the fuel cell.

### Related Art

Conventionally, for example, a power generation apparatus disclosed in Japanese unexamined patent application publication No. 2005-294190 (JP 2005-294190A) has been known. This apparatus includes a plurality of fuel cells connected in parallel, a single secondary battery (a battery) to which all the fuel cells are connected, a load device, and a controller, and is configured as a DC-DC converter-less apparatus. The controller controls activation and stop of the fuel cells and the battery based on the load and the activation time of the load device and the fuel cells.

### SUMMARY

### Technical Problems

The power generation apparatus disclosed in JP 2005-294190A configured as the DC-DC converter-less apparatus can thus have a simplified structure; however, the fuel cells may deteriorate to different degrees from each other. Here, if the fuel cells are activated without accounting for the differences in deterioration degree, the durability of a fuel cell with a larger deterioration degree than other fuel cells rapidly decreases, resulting in a decline in the durability of the entire power generation apparatus.

The disclosure has been made to address the above problems and has a purpose to provide a fuel cell system including a plurality of fuel cells and a battery, and no DC-DC converter, and configured to suppress deterioration of the fuel cells and hence suppress a decline in the durability of the fuel cell system.

### Means of Solving the Problems

To achieve the above-mentioned purpose, one aspect of the disclosure provides a fuel cell system including: a plurality of fuel cells connected in parallel; a single battery to which all the plurality of fuel cells are connected, wherein the fuel system does not include a DC-DC converter, wherein the fuel cell system further comprises a controller for controlling power generation of each of the plurality of fuel cells, and the controller is configured to simultaneously measure currents of the plurality of fuel cells, and control the power generation of each of the fuel cells based on differences in current measurement values between the fuel cells simultaneously measured.

According to the above-described configuration, the controller simultaneously measures the currents of the plurality of fuel cells and controls power generation of each of the fuel cells based on differences between the simultaneously measured current values of the fuel cells. Thus, the fuel cell system configured as above can use the fuel cell or fuel cells, which have higher current measurement values and have deteriorated less, for power generation, while avoiding the use of the fuel cell or fuel cells, which have lower current measurement values and may have deteriorated, for power generation. It is therefore possible to suppress the deterioration of each of the fuel cells and further suppress the durability decline of the entire fuel cell system.

### BRIEF DESCRIPTION OF THE DRAWINGS

FIG. 1 is a schematic configuration diagram of a fuel cell system in a first embodiment;

FIG. 2 is a schematic diagram showing a first FC stack and its related configurations in the first embodiment;

FIG. 3 is a graph showing one example of (A) a relationship between FC current and FC voltage and (B) a relationship between battery current and battery voltage, when no electric power is consumed by a motor in the first embodiment;

FIG. 4 is a graph showing one example of (A) a relationship between FC current and FC voltage of each of FC stacks that differ in deterioration degree and (B) a relationship between battery current and battery voltage, when no power is consumed by a motor in the first embodiment;

FIG. 5 is a flowchart showing one example of contents of a power generation control for three FC stacks in the first embodiment;

FIG. 6 is a determination value map defining warning determination value and abnormality determination value of FC current with respect to battery voltage in the first embodiment; and

FIG. 7 is a flowchart showing one example of contents of a power generation control for three FC stacks in a second embodiment.

### DETAILED DESCRIPTION OF THE EXEMPLARY EMBODIMENTS

### First Embodiment

A first embodiment of a fuel cell system of the disclosure, applied to a fuel cell system to be mounted in an electric vehicle, will be described below in detail, referring to the accompanying drawings.

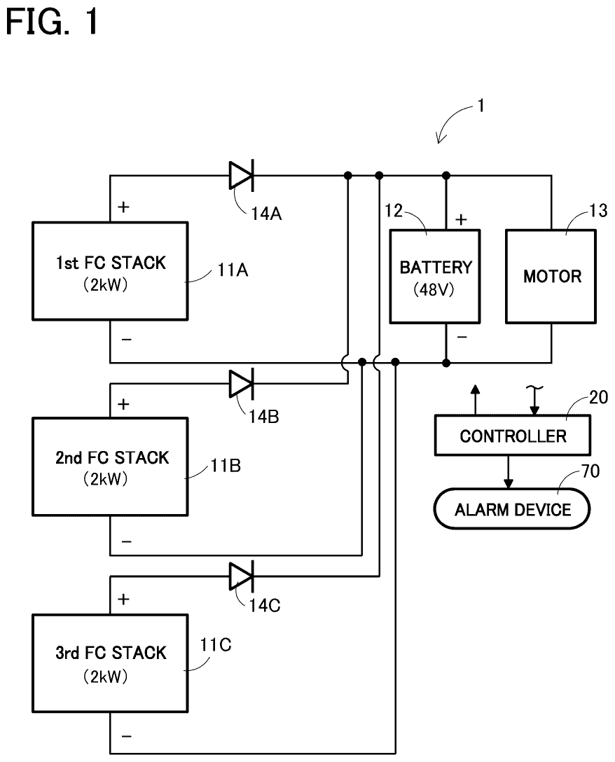

The configuration of a fuel cell system in the first embodiment will be described below. FIG. 1 is a schematic configuration diagram showing the fuel cell system in the first embodiment. This fuel cell system 1 is configured as a simple DC-DC converter-less system including no DC-DC converter, as shown in FIG. 1. This fuel cell system 1 includes three FC stacks, namely, a first FC stack 11A, a second FC stack 11B, and a third FC stack 11C, a single battery 12, and a single motor 13. As an alternative, an inverter may be provided instead of the motor 13.

The FC stacks 11A to 11C each generate an output power of 2 kW. Each of the FC stacks 11A to 11C and the motor 13 are connected to the battery 12 in parallel. To the FC stacks 11A, 11B, and 11C, diodes 14A, 14B, and 14C are respectively connected in series. Each FC stack 11A to 11C corresponds to one example of a “fuel cell” of the disclosure.

Here, a DC-DC converter is a device that coverts DC (direct current) voltage into another DC (direct current) voltage, and serves to convert voltage used in the system while maintaining it as direct current.

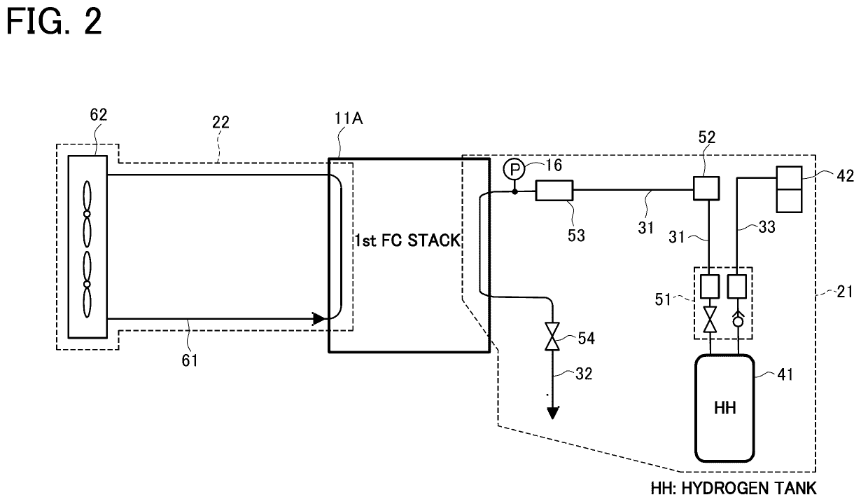

The related configurations of FC stacks will be described below. FIG. 2 is a schematic diagram showing the first FC stack 11A and its related configurations. The first FC stack 11A is configured as an open cathode system as shown in FIG. 2. Specifically, a hydrogen system 21 and an air and cooling system 22 are provided to the first FC stack 11A. The first FC stack 11A generates electric power, or electricity, by receiving hydrogen gas supplied from the hydrogen system 21 and air supplied from the air and cooling system 22.

The electric power generated by the first FC stack 11A is charged to the battery 12 via a wire. The electric power charged in the battery 12 is supplied to the motor 13 via a wire. The motor 13 is driven upon receipt of the electric power supplied from the first FC stack 11A and/or the battery 12 via wires.

The hydrogen system 21 is provided on the anode side of the first FC stack 11A. The hydrogen system 21 includes a hydrogen supply passage 31, an exhaust-drain passage 32, and a filling passage 33.

The hydrogen supply passage 31 is a passage for supplying hydrogen from a hydrogen tank 41 that stores hydrogen to the first FC stack 11A. The exhaust-drain passage 32 is a passage for discharging out hydrogen, i.e., hydrogen off-gas, and drained water, which are emitted from the first FC stack 11A.

The hydrogen system 21 includes, in the hydrogen supply passage 31, a hydrogen valve 51, a hydrogen pressure reducing valve 52, and an injector 53, which are arranged in this order from a hydrogen tank 41 side. The filling passage 33 is a passage for filling hydrogen from a supply port 42 to the hydrogen tank 41.

The hydrogen valve 51 is an electromagnetic valve for switching between supply and shutoff of hydrogen from the hydrogen tank 41 to the hydrogen supply passage 31. The hydrogen pressure reducing valve 52 is a pressure regulating valve for reducing the pressure of hydrogen and consists of, for example, an electromagnetic valve. The injector 53 is an electromagnetic valve for injecting the hydrogen introduced from the hydrogen tank 41 toward a downstream side. This injector 53 is configured to regulate the injection pressure of hydrogen (namely, hydrogen pressure) by, for example, moving a needle valve to adjust the opening degree of an injection port.

In the exhaust-drain passage 32, the exhaust-drain valve 54 is placed. This exhaust-drain valve 54 is an electromagnetic valve for switching between discharge and shutoff of hydrogen off-gas and water.

In the hydrogen system 21, a pressure sensor 16 is provided in the hydrogen supply passage 31 between the injector 53 and the first FC stack 11A. This pressure sensor 16 is a sensor for measuring the pressure of hydrogen injected from the injector 53, that is, the pressure of hydrogen to be supplied to the first FC stack 11A.

On the other hand, the air and cooling system 22 is provided on the cathode side of the FC stack 11A. The air and cooling system 22 for the FC stack 11A includes an air passage 61 for circulating air and an electrically-operated air supply fan 62 for supplying air flowing through the air passage 61 to the FC stack 11A. In the present embodiment, the open cathode system is configured such that the air system is also used as a cooling system.

In the above-described configuration related to the first FC stack 11A, the hydrogen supplied to the first FC stack 11A via the hydrogen supply passage 31 is used for power generation in the first FC stack 11A and then discharged out as hydrogen off-gas from the first FC stack 11A via the exhaust-drain passage 32. The air supplied to the first FC stack 11A via the air passage 61 is used for power generation in the first FC stack 11A and then discharged out as air off-gas from the first FC stack 11A.

The electric power generated by the first FC stack 11A will be charged to the battery 12 and used for driving the motor 13.

The second FC stack 11B and the third FC stack 11C are each provided with the related configurations identical to those described above and will be operated in the same manner as above. The details thereof are omitted herein.

The fuel cell system 1 further includes a controller 20 for controlling this system 1 as shown in FIG. 1. The controller 20 includes, for example, a processing unit such as a CPU, a memory unit including e.g. a ROM for storing control programs and control data to be processed by the CPU and a RAM used as various operation regions for control process, and an input/output interface unit. The controller 20 executes various controls of the fuel cell system 1 in accordance with the control programs stored in the memory unit. In the present embodiment, specifically, the controller 20 is configured to control each device of the hydrogen system 21 and the air and cooling system 22 in order to control the fuel cell system 1.

In the present embodiment, the controller 20 internally includes a voltage measuring circuit and is configured to measure the voltage of the battery 12 (i.e., battery voltage) using this voltage measuring circuit. The controller 20 further internally includes a current measuring circuit and is configured to measure the current of the electric power generated by each FC stack 11A to 11C (i.e., FC current) using this current measuring circuit. The controller 20 is configured to control power generation of each FC stack 11A to 11C based on the measured battery voltage and the measured FC current.

The DC-DC converter-less system will be described below. The fuel cell system 1 in the present embodiment is configured as a system having no DC-DC converter, namely, a DC-DC converter-less system. In the fuel cell system 1, accordingly, the FC voltage of each FC stack 11A to 11C is equal or nearly equal to the battery voltage of the battery 12. Consequently, the FC current depends on the battery voltage. In other words, the fuel cell system 1 is configured to supply the electric power generated by the FC stacks 11A to 11C to the battery 12 and the motor 13 without converting the value of the FC voltage into another voltage value.

In this fuel cell system 1, the FC voltage is equal to the battery voltage and thus each FC stack 11A to 11C performs an operation of “uncontrolled power generation” according to the battery voltage during power generation. When the charging rate of the battery 12 increases, the air supply fan 62 is stopped to decrease the FC voltage below the battery voltage, causing each FC stack 11A to 11C to intermittently stop the power generation to perform an operation of “low-current power generation”. These operations can improve fuel efficiency.

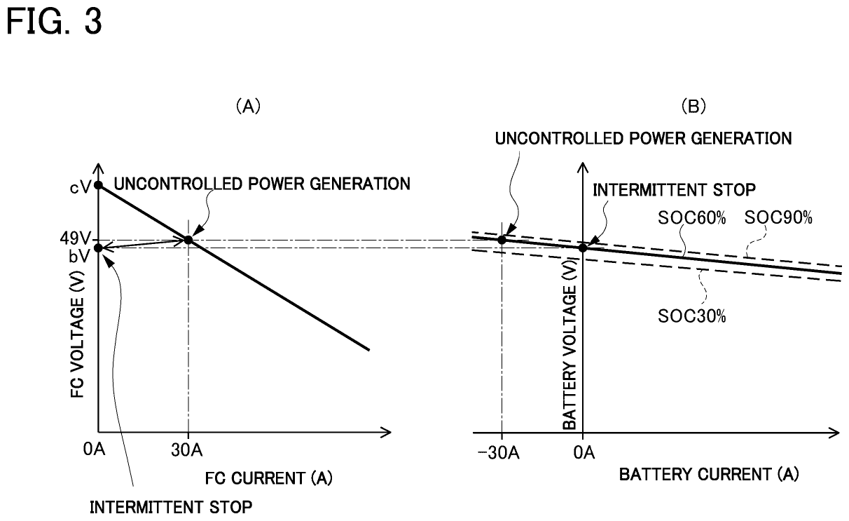

FIG. 3 is a graph showing one example of (A) the relationship between FC current and FC voltage and (B) the relationship between battery current and battery voltage in the fuel cell system 1, when no electric power is consumed by the motor 13. In FIG. 3 (B), the relationship between battery current and battery voltage is shown for cases where the SOC (state of charge) of the FC stack is 30%, 60%, and 90%. In the following, the case where the SOC is 60% will be described as an example. As shown in FIG. 3, when the motor 13 is not consuming electric power, assuming that the battery voltage is 49V, the FC voltage is equal to the battery voltage, 49V. Accordingly, the FC current is 30 A. Thus, the FC output power and the battery output power are determined as below:

$$FC output power = 49 V \times 30 A = 1.5 kW$$

$$Battery output power = 49 V \times - 30 A = - 1.5 kW .$$

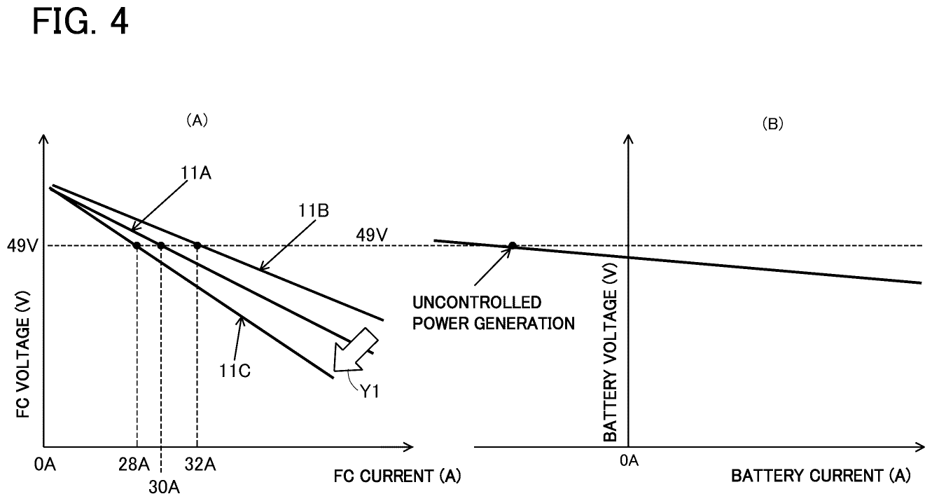

Here, in the fuel cell system 1 including three FC stacks 11A to 11C, these FC stacks 11A to 11C may deteriorate to different degrees from each other. FIG. 4 is a graph showing one example of (A) the relationship between FC current and FC voltage of each FC stack 11A to 11C having different deterioration degrees and (B) the relationship between battery current and battery voltage, when no electric power is consumed by the motor 13.

In FIG. 4, the deterioration degrees of the FC stacks 11A to 11C are shown as below. The FC current of the third FC stack 11C is 28 A, indicating the largest deterioration degree. The FC current of the first FC stack 11A is 30 A, indicating the second-largest deterioration degree. The FC current of the second FC stack 11B is 32 A, indicating the smallest deterioration degree. The deterioration degrees of the FC stack 11A, 11B, and 11C are greater as indicated by a thick arrow Y1 in FIG. 4 (A). In other words, the FC stacks 11B, 11A, and 11C have deteriorated more largely in this order. If these three FC stacks 11A to 11C are operated without taking account of deterioration differences therebetween, the durability decline of the third FC stack 11C and the first FC stack 11A, each having deteriorated more greatly than others, may be accelerated, resulting in a decline in the durability of the entire fuel cell system 1. Therefore, in the present embodiment, the power generation of the three FC stacks 11A to 11C is controlled as below.

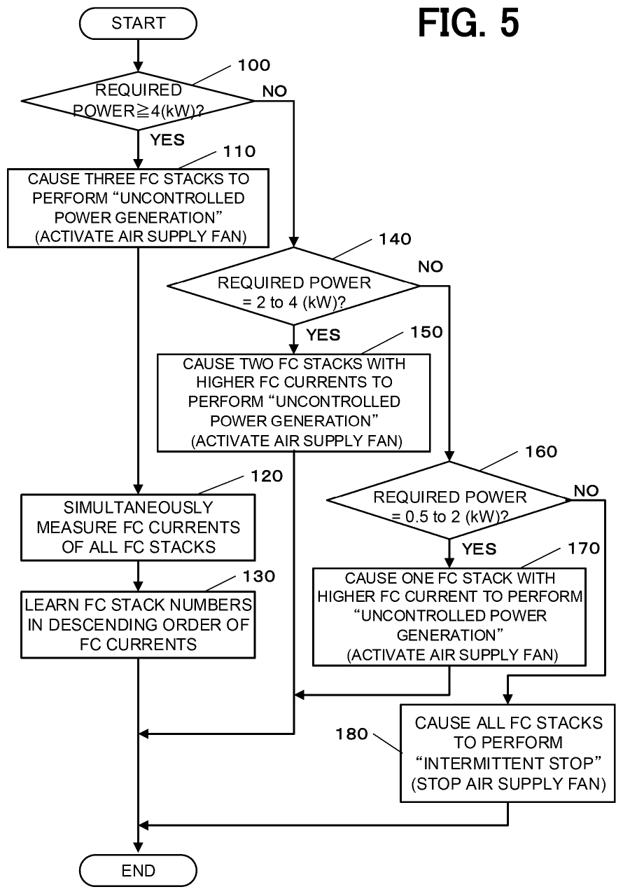

The power generation control of three FC stacks in the present embodiment will be described below. FIG. 5 is a flowchart showing one example of contents of the power generation control of three FC stacks 11A to 11C in the present embodiment. The control program shown in this flowchart is stored in the memory unit of the controller 20.

When the process enters the routine shown in FIG. 5, in step 100, the controller 20 determines whether or not a required output power of the fuel cell system 1 is 4 (KW) or more. In the present embodiment, the FC stacks 11A to 11C are set to generate the same output power of 2 (KW). This output power of 4 (KW) can be satisfied by power generation of two of the three FC stacks 11A to 11C. Further, the required output power is determined based on the driver's operation of an accelerator pedal of an electric vehicle in which the fuel cell system 1 is mounted. When an affirmative result (YES) is obtained in this step 100, the controller 20 advances the process to step 110. When a negative result (NO) is obtained in step 100, the controller 20 shifts the process to step 140.

In step 110, the controller 20 causes three FC stacks 11A to 11C to perform the “uncontrolled power generation”. For this purpose, the controller 20 activates the air supply fans 62 of the air and cooling systems 22.

In step 120, the controller 20 then simultaneously measures the FC currents of all the FC stacks 11A to 11C.

In step 130, furthermore, the controller 20 learns the FC current of each FC stack 11A to 11C and also learns the numbers (i.e., the identification numbers) of the FC stacks 11A to 11C in the descending order of FC currents. Then, subsequent process is temporarily terminated.

In contrast, in step 140, the controller 20 determines whether or not the required output power is in the range of 2 to 4 (KW). When YES in step 140, the controller 20 advances the process to step 150. When NO in step 140, the controller 20 shifts the process to step 160.

In step 150, the controller 20 causes two FC stacks with highest and second-highest FC currents, among the three FC stacks 11A to 11C, to perform the uncontrolled power generation. For this purpose, the controller 20 activates the air supply fans 62 of the air and cooling systems 22 of the relevant two FC stacks and temporarily terminates subsequent process.

In contrast, in step 160, the controller 20 determines whether or not the required output power is in the range of 0.5 to 2 (KW). When YES in step 160 the controller 20 advances the process to step 170. When NO in step 160, the controller 20 shifts the process to step 180.

In step 170, the controller 20 causes one FC stack with the highest FC current, among the three FC stacks 11A to 11C, to perform the uncontrolled power generation. For this purpose, the controller 20 activates the air supply fan 62 of the air and cooling system 22 of the relevant FC stack and temporarily terminates subsequent process.

In contrast, in step 180, the controller 20 causes all the FC stacks 11A to 11C to intermittently stop. For this purpose, the controller 20 stops the air supply fans 62 and temporarily terminates subsequent process.

According to the above-described power generation control, the controller 20 is configured to simultaneously measure the FC currents of three FC stacks 11A to 11C. The controller 20 is also configured to control the power generation of each of the three FC stacks 11A to 11C based on differences in FC current between the FC stacks 11A to 11C measured at the same time.

According to the above-described power generation control, the controller 20 learns the FC currents of the FC stacks 11A to 11C measured at the same time. Further, the controller 20 is configured to preferentially cause the FC stack(s) with a higher FC current among three FC currents learned as above to generate electric power, and change the number of FC stacks 11A to 11C to be used for power generation according to the required output power of the fuel cell system 1.

According to the above-described power generation control, the maximum required output power of the fuel cell system 1 is set to be satisfied by “4 (KW)”, that is, by power generation of two (N=2) of the FC stacks 11A to 11C. The total number of FC stacks 11A to 11C is set to 3, i.e., “N+1” or more. Then, the controller 20 is configured to use two of the FC stacks 11A to 11C, corresponding to two (N=2) higher FC currents among the three FC currents leant as above.

The deterioration abnormality diagnosis of FC stack in the present embodiment will be described below. In the present embodiment, as shown in FIG. 1, the controller 20 is configured to diagnose abnormalities due to deterioration (deterioration abnormality) of each of the FC stacks 11A to 11C. Further, an alarm device 70 is provided to notify a diagnostic result. The controller 20 controls the alarm device 70 according to the diagnostic result.

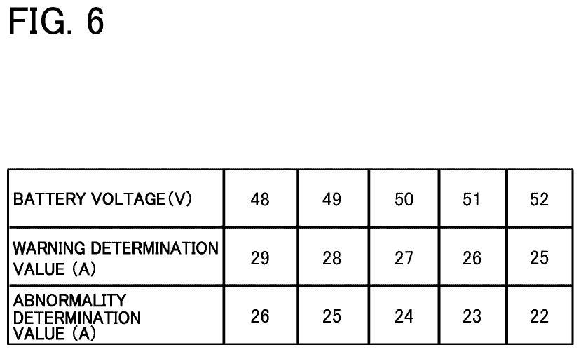

In the present embodiment, each FC stack 11A to 11C is diagnosed for the abnormality due to deterioration based on FC current differences according to a battery voltage. FIG. 6 is a table showing a determination value map defining warning determination value and abnormality determination value of FC current with respect to battery voltage. In FIG. 6, when the battery voltage is 48V, 49V, 50V, 51V, and 52V, the warning determination value related to the FC current is respectively 29 A, 28 A, 27 A, 26 A, and 25 A. Here, the warning determination value corresponds to one example of a “first determination value” of the disclosure, and the abnormality determination value corresponds to one example of a “second determination value” of the disclosure.

In FIG. 6, when the FC current becomes a warning determination value with respect to the battery voltage, the controller 20 activates the alarm device 70 to provide a warning notification. This warning notification is to notify that at least one of the FC stacks 11A to 11C may cause deterioration. For example, when the battery voltage is 48V and the FC current becomes 29 A, the controller 20 activates the alarm device 70 to notice a warning.

In contrast, in FIG. 6, when the FC current is an abnormality determination value with respect to the battery voltage, the controller 20 activates the alarm device 70 to provide an abnormality notification. This abnormality notification is to notify that at least one of the FC stacks 11A to 11C has already deteriorated. For example, when the battery voltage is 48V and the FC current becomes 26 A, the controller 20 activates the alarm device 70 to notify abnormality.

In the present embodiment, for example, the alarm device 70 is configured to sound and blink. In this case, the operation for the warning notification and the operation for the abnormality notification can be distinguished by causing the sounding and the blinking of the alarm device 70 in different patterns. Furthermore, the controller 20 stores the diagnostic result on the deterioration of each FC stack 11A to 11C in the memory unit. This diagnostic result can be confirmed by retrieval from the memory unit during periodic checks of the vehicle. Alternatively, the alarm device 70 may include a communication device. In this case, the communication device may communicate with a server to transmit commands to the controller 20 to prompt replacement of the relevant FC stack of the electric vehicle or inhibit the operation of the relevant FC stack.

In the aforementioned deterioration abnormality diagnosis, when the FC current is lower than the warning determination value, the controller 20 causes the alarm device 70 to provide the warning notification, indicating that the FC stacks 11A to 11C may be deteriorating. Further, when the FC current is lower than the abnormality determination value that is lower than the warning determination value, the controller 20 activates the alarm device 70 to provide the abnormality notification, indicating that the FC stacks 11A to 11C may be abnormal due to deterioration.

In the foregoing deterioration abnormality diagnosis, the controller 20 is configured to measure the voltage of the battery 12. The controller 20 is configured to change the warning determination value and the abnormality determination value according to the battery voltage.

The operations and effects of the fuel cell system of the present embodiment will be described below. According to the configuration of the fuel cell system 1 in the first embodiment described above, the controller 20 simultaneously measures the currents of the three FC stacks 11A to 11C, and controls the power generation of each of the three FC stacks 11A to 11C based on differences in FC current between the FC stacks 11A to 11C measured at the same time. This makes it possible to use the FC stack(s) having higher FC current and less deterioration among the FC stacks 11A to 11C for power generation, while avoiding the use of the FC stack(s) having lower FC current and that may have deteriorated. This configuration can suppress the deterioration of each of the three FC stacks 11A to 11C and further suppress the durability decline of the entire fuel cell system 1.

According to the configuration in the first embodiment, the controller 20 preferentially causes the FC stack(s) with higher FC current, among the three FC stacks 11A to 11C whose FC currents have been learnt, to generate electric power, and also changes the number of FC stacks 11A to 11C to be used for power generation, according to the required output power of the fuel cell system 1. This configuration enables power generation corresponding to the required output power while avoiding the use of the FC stack(s) that has lower FC current and may have deteriorated among the FC stacks 11A to 11C. Consequently, the fuel cell system 1 can respond to the required output power while suppressing the widening of deterioration differences between the three FC stacks 11A to 11C.

According to the configuration in the first embodiment, the controller 20 uses two FC stacks corresponding to the first-highest and second-highest FC currents among the (2+1) FC currents having been learnt, and thus remaining one of the FC stacks 11A to 11C, not used for power generation, can be reserved as a spare, which can extend the durability of the fuel cell system 1.

According to the configuration in the present embodiment, when the FC current is lower than the warning determination value (the first current determination value), the controller 20 causes the alarm device 70 to provide the warning notification, allowing early notification to a user that the FC stacks 11A to 11C may have deteriorated. Further, when the FC current is lower than the abnormality determination value (the second current determination value), the controller 20 causes the alarm device 70 to provide the abnormality notification, allowing early notification to a user that the FC stacks 11A to 11C may be abnormal due to deterioration. Therefore, a user can early recognize the possibility of deterioration and the deterioration abnormality of each of the three FC stacks 11A to 11C, and take appropriate action at an early stage.

According to the configuration in the first embodiment, the controller 20 variously sets the warning determination value and the abnormality determination value for determining the possibility of deterioration and the deterioration abnormality of the FC stacks 11A to 11C, according to the battery voltage values. Therefore, the controller 20 can accurately determine the deterioration of the FC stacks 11A to 11C regardless of the differences in battery voltage state.

### Second Embodiment

Next, a second embodiment of a fuel cell system, embodied in a fuel cell system to be mounted in an electric vehicle, will be described below, referring to the accompanying drawings. In the following description, the identical or similar configurations to those in the first embodiment will be assigned with the same reference signs as those in the first embodiment and their details will be omitted. The following description will be given with a focus on differences from the first embodiment.

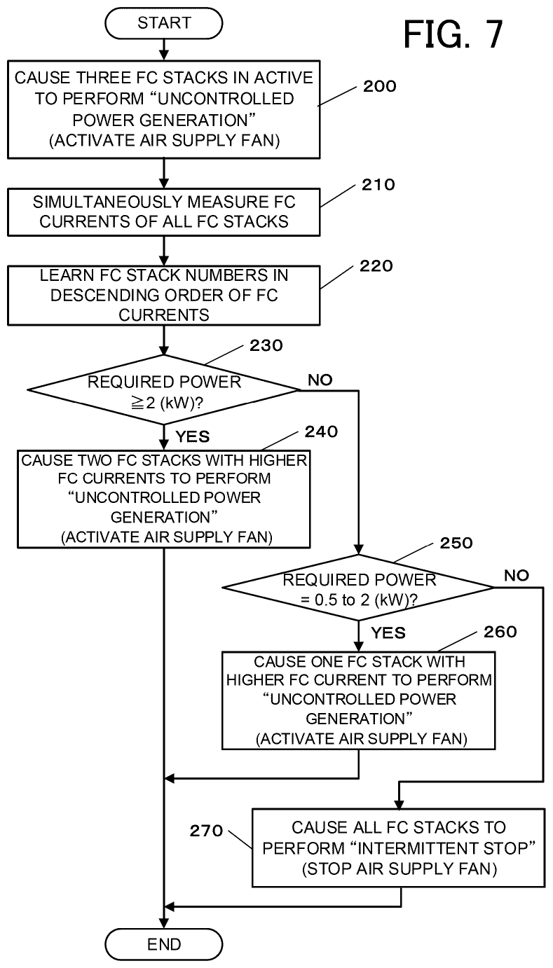

The power generation control of three FC stacks in the present embodiment will be described below. The second embodiment differs from the first embodiment in the contents of the power generation control of the three FC stacks 11A to 11C. FIG. 7 is a flowchart showing one example of another contents of the power generation control of the three FC stacks 11A to 11C in the present embodiment. The control program shown in this flowchart is stored in the memory unit of the controller 20.

When the process enters the routine shown in FIG. 7, in step 200, the controller 20 causes the three FC stacks 11A to 11C to perform the “uncontrolled power generation” in an active state (e.g., once per trip). For this purpose, the controller 20 activates the air supply fan 62 of the air and cooling system 22.

In step 210, the controller 20 then simultaneously measures the FC currents of all of the FC stacks 11A to 11C.

In step 220, subsequently, the controller 20 learns the FC currents of the FC stacks 11A to 11C and further learns the numbers (the identification numbers) of the FC stacks 11A to 11C in the descending order of the FC currents.

In step 230, the controller 20 determines whether or not the required output power is 2 (KW) or more. When YES in step 230, the controller 20 advances the process to step 240. When NO in step 230, the controller 20 shifts the process to step 250.

In step 240, the controller 20 causes two FC stacks corresponding to top two FC currents, among the FC stacks 11A to 11C, to perform the uncontrolled power generation. For this purpose, the controller 20 activates the air supply fan 62 and temporarily stops subsequent process.

In contrast, in step 250, the controller 20 determines whether or not the required output power is in the range of 0.5 to 2 (KW). When YES in step 250, the controller 20 advances the process to step 260. When NO in step 250, the controller 20 shifts the process to step 270.

In step 260, the controller 20 causes one FC stack having the highest FC current, among the FC stacks 11A to 11C, to perform the uncontrolled power generation. For this purpose, the controller 20 activates the air supply fan 62 and temporarily stops subsequent process.

In contrast, in step 270, the controller 20 intermittently stops all the FC stacks 11A to 11C. For this purpose, the controller 20 stops the air supply fan 62 and temporarily terminates subsequent process.

The operations and effects of the fuel cell system of the present embodiment will be described below. According to the fuel cell system 1 configured as above in the second embodiment, it is possible to achieve the equivalent operations and effects to the first embodiment, even though the contents of the power generation control of the three FC stacks 11A to 11C differ from those of the first embodiment.

The foregoing embodiments are mere examples and give no limitation to the disclosure. The disclosure may be embodied in other specific forms without departing from the essential characteristics thereof.
(1) In the foregoing embodiments, three FC stacks 11A to 11C are provided as a plurality of fuel cells, but the number (N) of FC stacks is not limited to three.
(2) In the foregoing embodiments, the fuel cell system 1 is applied to those mounted in electric vehicles, but may be applied to those mounted in any objects other than the electric vehicles.
(3) In the foregoing embodiments, each of the FC stacks 11A to 11C is configured with the open cathode system using the air system and the cooling system in common, but can be configured with a closed cathode system using the air system and the cooling system separately.

### INDUSTRIAL USABILITY

The disclosure is applicable to, for example, a fuel cell system to be mounted in an electric vehicle.

### REFERENCE SIGNS LIST

1 Fuel cell system
11A First FC stack
11B Second FC stack
11C Third FC stack
12 Battery
20 Controller
70 Alarm device

What is claimed is:

1. A fuel cell system comprising:
a plurality of fuel cells connected in parallel;
a single battery to which all the plurality of fuel cells are connected,
wherein the fuel system does not include a DC-DC converter,
wherein the fuel cell system further comprises a controller for controlling power generation of each of the plurality of fuel cells, and
the controller is configured to simultaneously measure currents of the plurality of fuel cells, and control the power generation of each of the fuel cells based on differences in current measurement values between the fuel cells simultaneously measured.

2. The fuel cell system according to claim 1, wherein the controller learns the current measurement values simultaneously measured, preferentially causes the fuel cell having a high current measurement value among the learned current measurement values to generate power, and changes a number of the fuel cells caused to generate power according to a required output power of the fuel cell system.

3. The fuel cell system according to claim 2, wherein
output powers of the plurality of fuel cells are set to be equal to each other,
a maximum required output power of the fuel cell system is set to be satisfied by power generation of N fuel cells among the plurality of fuel cells, and a total number of the plurality of fuel cells is set to N+1 or more, and
the controller uses the N fuel cells for power generation, which corresponds to N higher current measurement values in descending order among the learned current measurement values.

4. The fuel cell system according to claim 1 further comprising an alarm device for notifying deterioration of the fuel cells,
wherein when at least one of the current measurement values of the fuel cells is lower than a first current determination value, the controller activates the alarm device to provide a warning notification that the fuel cells may have deteriorated,
when at least one of the current measurement values of the fuel cells is lower than a second current determination value that is lower than the first current determination value, the controller activates the alarm device to provide an abnormality notification that the fuel cells are abnormal due to deterioration.

5. The fuel cell system according to claim 4, wherein the controller is configured to measure voltage of the battery, and change the first current determination value and the second current determination value according to a measurement value of the voltage.
